(19) United States
(12) Patent Application Publication
(10) Pub. No.: US 2024/0424684 A1
(43) Pub. Date: Dec. 26, 2024

(54) PAINTING DEVICE HAVING A MOVABLE ROBOTIC ARM CARRYING A TOOL AND A MOVABLE PIECE OF EQUIPMENT CONNECTED BY AN UMBILICAL CONNECTION TO THE TOOL

(71) Applicants: Airbus SAS, BLAGNAC (FR); Airbus Operations S.L., GETAFE (ES); Airbus Operations GmbH, HAMBURG (DE)

(72) Inventors: Wladislav LAGUTIN, HAMBURG (DE); Juan Francisco GARCIA AMADO, GETAFE (ES); Boris MORINIERE, ROCHEFORT (FR)

(21) Appl. No.: 18/734,340

(22) Filed: Jun. 5, 2024

(30) Foreign Application Priority Data
Jun. 26, 2023 (FR) 2306618

(51) Int. Cl. B25J 11/00

(52) U.S. Cl. CPC B25J 11/0075

(57) ABSTRACT

A painting device including at least one guide system, at least a first movable support configured to move along the guide system, a robotic arm secured to the first movable support, at least a first tool connected to the free end of the robotic arm, and at least a first piece of equipment connected to the first tool by at least one umbilical connection, the first piece of equipment being movable and connected to the first movable support. This configuration makes it possible to reduce the length of the umbilical connection. A painting installation having at least one such painting device is also provided.

### CROSS-REFERENCES TO RELATED APPLICATIONS

This application claims the benefit of French Patent Application Number 2306618 filed on Jun. 26, 2023, the entire disclosures of which are incorporated herein by way of reference.

### FIELD OF THE INVENTION

The present application relates to a painting device having a movable robotic arm carrying a tool and a movable piece of equipment connected by an umbilical connection to the tool, and to a painting installation comprising at least one such painting device.

### BACKGROUND OF THE INVENTION

According to an embodiment described in document US 20150375390, a painting installation configured to paint an aircraft comprises a plurality of painting devices each having a platform, a support member which is movable relative to the platform, and a robotic arm connected to the support member. The support member comprises a mast and a horizontal crosspiece which is movable vertically along the mast, the robotic arm being movable along the crosspiece of the support member. In the case of a large aircraft, the mast of the support member has a height greater than 10 m and the crosspiece has a length of several meters.

According to an embodiment shown in FIG. 1, a painting device 10 comprises a guide system 12, such as the crosspiece of a support member, and a robotic arm 14 which is movable along the guide system 12. The robotic arm 14 comprises a base 16 which is movable along the guide system 12, a free end 18 configured to carry a tool 20, at least first and second segments 22, 22′, and articulated joints 24 connecting the first and second segments 22, 22′ to one another and the first segment 22 to the base 16.

For each robotic arm 14, the painting installation comprises a control and power supply system 26 having a control station 26.1, a power supply 26.2 and a bundle of cables 26.3 connecting the control station 26.1 and the power supply 26.2 to the robotic arm 14.

In order to supply the tool 20 with paint, the painting installation comprises a paint supply system 28 having at least one fixed paint reservoir 28.1 and at least one paint line 28.2 configured to convey the paint from the paint reservoir 28.1 to the tool 20.

The bundle of cables 26.3 and the paint line 28.2 have considerable lengths, several tens of meters in the case of a painting device adapted to an aircraft, in order to follow the movements of the robotic arm 14 when it moves along the mast and/or the crosspiece.

However, it is difficult for the paint to flow in a paint line 28.2 measuring several tens of meters, and relatively powerful and therefore energy-consuming pumps are required. Moreover, because the paint line 28.2 is very long, the operations of cleaning the line, when the paint is changed, for example, cause a considerable loss of paint, consume a large amount of cleaning products and require a long time.

### SUMMARY OF THE INVENTION

The present invention aims to remedy all or some of the disadvantages of the prior art.

To this end, the invention relates to a painting device comprising at least one guide system, at least a first movable support configured to move along the guide system, a robotic arm secured to the first movable support and having a free end, at least a first tool connected to the free end of the robotic arm, and at least a first piece of equipment connected by at least one umbilical connection to the first tool. According to the invention, the first piece of equipment associated with the first tool is connected to the first movable support carrying the robotic arm.

This solution makes it possible to reduce the length of the umbilical connection connecting the first piece of equipment and the first tool, which facilitates the flow of a fluid in the umbilical connection.

According to another feature, the first piece of equipment is connected to a second movable support, which is itself connected to the first movable support, configured to move along the guide system.

According to another feature, the first and second movable supports are connected by an articulated connection.

According to another feature, the first tool is connected to the free end of the robotic arm by a first releasable connection.

According to another feature, the first piece of equipment is connected to the first movable support by a releasable connection.

According to another feature, the first piece of equipment is secured to a second movable support connected by a releasable connection to the first movable support.

According to another feature, the first tool is associated with at least a first piece of equipment dedicated to the first tool and connected directly or indirectly to the first tool by a first umbilical connection, and with at least a second piece of equipment common to a plurality of tools and connected directly or indirectly to the first tool by a second umbilical connection, each first piece of equipment being releasably connected to the first movable support, each second piece of equipment being permanently connected to the first movable support.

According to another feature, at least one umbilical connection is attached to the robotic arm by at least one releasable connection.

The invention relates also to a painting installation adapted for painting an aircraft, comprising at least one painting device according to one of the preceding features.

According to another feature, the painting installation comprises a plurality of guide systems arranged symmetrically relative to a vertical mid-plane and distributed around a circle having a diameter greater than that of a fuselage of an aircraft to be painted.

According to another feature, the painting installation comprises a painting booth which has walls forming an enclosure and at least one structure supporting the walls and each guide system.

According to another feature, the painting installation comprises at least one storage zone configured to store at least one tool, at least one tool accessory or at least one consumable and positioned as a continuation of the painting booth, at least one guide system being sufficiently long to be positioned in part in the tool storage zone.

According to another feature, the storage zone comprises at least one support configured to carry at least one tool, at least one tool accessory or at least one consumable, the support and the guide system being arranged such that a robotic arm sliding along the guide system is able to reach a tool, a tool accessory or a consumable positioned on the support.

According to another feature, the painting installation comprises at least one support carriage configured to carry at least one tool.

### BRIEF DESCRIPTION OF THE DRAWINGS

Other features and advantages will become apparent from the following description of the invention, the description being given solely by way of example, in relation to the accompanying drawings, in which:

FIG. 1 is a schematic representation of a painting device illustrating an embodiment of the prior art,

FIG. 2 is a schematic representation of a painting device illustrating an embodiment of the invention,

FIG. 3 is a schematic representation of the painting device shown in FIG. 2 without a tool,

FIG. 4 is a schematic representation of a tool support carriage illustrating an embodiment of the invention,

FIG. 5 is a front view of a painting device illustrating an embodiment of the invention,

FIG. 6 is a front view of a painting device illustrating another embodiment of the invention,

FIG. 7 is a perspective view of a painting installation, having a painting booth in the open state, illustrating an embodiment of the invention,

FIG. 8 is a perspective view of a structure of a painting booth, in the open state, illustrating an embodiment of the invention,

FIG. 9 is a perspective view of the structure of the painting booth shown in FIG. 8 in the closed state,

FIG. 10 is a schematic cross section of a structure of a painting booth illustrating an embodiment of the invention,

FIG. 11 is a perspective view of a lower part of a painting booth illustrating an embodiment of the invention,

FIG. 12 is a perspective view of a tool storage station illustrating an embodiment of the invention.

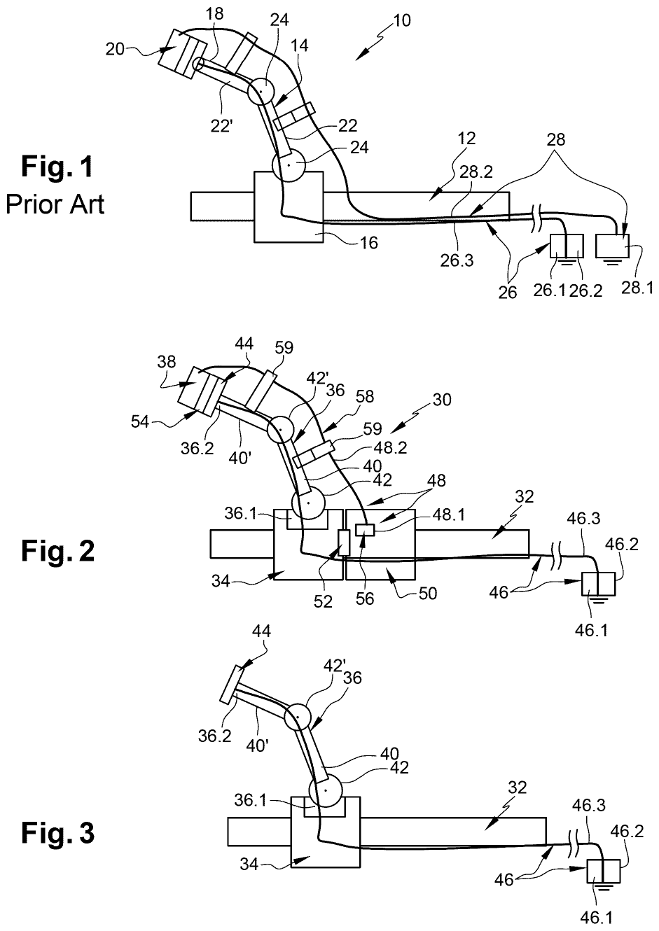

### DETAILED DESCRIPTION OF THE PREFERRED EMBODIMENTS

According to an embodiment shown in FIGS. 2, 3, 5 and 6, a painting device 30 comprises at least one guide system 32, at least a first movable support 34 configured to move along the guide system 32, a robotic arm 36 secured to the first movable support 34, and at least a first tool 38 moved by the robotic arm 36.

The robotic arm 36 comprises a first end 36.1 secured to the first movable support 34, a free end 36.2, a plurality of segments 40, 40′, and at least one articulated joint 42 connecting the segments 40, 40′ to one another and having at least one pivot connection. Of course, the invention is not limited to this type of robotic arm 36. Thus, the robotic arm could be a cartesian-type robotic arm.

According to an embodiment shown in FIGS. 5 and 6, the first end 36.1 is a base fixed to the first movable support 34. The robotic arm 36 comprises first and second segments 40, 40′, the first segment 40 being connected to the base by a first articulated joint 42, the first and second segments 40, 40′ being connected to one another by a second articulated joint 42′. The invention is not limited to this number of segments. Generally, the robotic arm comprises not more than three segments, and each articulated joint 42 permits only rotational movements.

As is shown in FIG. 2, the first tool 38 is connected directly or indirectly to the free end 36.2. According to one embodiment, the first tool 38 is a tool configured to spray paint.

According to one configuration, the painting device 30 comprises a tool holder 44, also called an effector, secured to the free end 36.2 of the robotic arm 36 and configured to carry the first tool 38. The tool holder 44 can be connected to the free end 36.2 by an articulated joint.

The painting device 30 also comprises a control and power supply system 46 configured to supply power to and to remotely control the robotic arm 36. According to one embodiment, the control and power supply system has a control station 46.1, a power supply 46.2, and a bundle of cables 46.3 connecting the control station 46.1 and the power supply 46.2 to the robotic arm 36. According to one arrangement, the bundle of cables 46.3 passes along the guide system 32 and optionally along or inside the segments 40, 40′ of the robotic arm 36.

According to one embodiment, the tool holder 44 comprises at least one actuator, especially for holding or releasing the first tool 38. According to a first variant, the control and power supply system 46 is configured to supply power to and to remotely control the robotic arm 36 and the tool holder 44. According to a second variant, the painting device 30 comprises a first control and power supply system 46 configured to supply power to and to remotely control the robotic arm 36, and a second control and power supply system configured to supply power to and to remotely control the tool holder 44.

The painting device 30 comprises at least a first fluid supply system 48 configured to supply the first tool 38 with fluid. According to one embodiment, the first fluid supply system 48 comprises at least one fluid supply 48.1 and at least one fluid line 48.2 configured to convey a fluid between the fluid supply 48.1 and the first tool 38. The fluid line 48.2 is connected to the first tool 38 directly or/and by way of the tool holder 44, as appropriate.

When the first tool 38 is configured to spray paint, the fluid supply 48.1 is a reservoir configured to store paint, and the first fluid supply system 48 comprises at least one pump for conveying the paint from the reservoir to the first tool 38.

According to a particular feature of the invention, the painting device 30 comprises at least one support 50 carrying the fluid supply 48.1 and connected to the first movable support 34. According to a first configuration, the support 50 and the first movable support 34 are connected by a rigid and permanent connection or form only the same single element. According to a second configuration, the support 50 is a second movable support, separate from the first movable support 34, configured to move along the guide system 32 connected by a connection 52 to the first movable support 34. According to one arrangement, this connection 52 is articulated. Whatever the configuration, the fluid supply 48.1 is close to the robotic arm 36. Consequently, the fluid line 48.2 has a length that is reduced by the order of several meters, which facilitates the flow of the fluid. Moreover, when the paint applied by the first tool 38 is changed, the operation of cleaning the fluid line 48.2 causes fewer losses of product (paint, varnish, etc.), lasts a shorter time and requires fewer cleaning products owing to the reduced length of the fluid line 48.2.

According to one configuration, the painting device 30 comprises a control and power supply system 48′ configured to supply power to and to remotely control the first tool 38, having a control station and/or a power supply as well as a bundle of cables connecting the control station and/or the power supply 46.2 to the first tool 38.

According to a preferred embodiment, the first tool 38 is connected to the free end 36.2 of the robotic arm 36 by a first releasable connection 54. In addition, the first fluid supply system 48 associated with the first tool 38 is connected to the first movable support 34 by a releasable connection. According to a configuration shown in FIG. 3, when the first fluid supply system 48 is fixed to a second movable support 50, the connection 52 connecting the first and second movable supports 34, 50 is a releasable connection.

A releasable connection is understood as being a connection which can rapidly be released and reattached repeatedly without being damaged. According to one configuration, the first releasable connection 54 connecting the first tool 38 to the free end 36.2 is configured so that it can be attached and released in an automated manner.

According to one embodiment, when the first tool 38 is connected to the free end 36.2 of the robotic arm 36 by a first releasable connection 54, the painting device 30 comprises, in addition to the first tool 38, at least a second tool configured to be attached directly or indirectly to the free end 36.2 of the robotic arm 36. Thus, the first and second tools 38 are connected in turn to the free end 36.2 of the robotic arm 36.

According to this embodiment, the painting device 30 is not dedicated exclusively to painting operations. It may be used to perform operations which are complementary to the painting operation, such as operations of preparing the surfaces to be painted (sanding or degreasing).

As is shown in FIGS. 5 and 6, whatever the embodiment, the painting device 30 comprises a first tool 38 as well as at least one piece of equipment 56 connected directly or indirectly to the first tool 38 by at least one umbilical connection 58.

The piece of equipment 56 is chosen from a fluid and/or power supply system, or a fluid suction system. The invention is not limited to these pieces of equipment. By way of example, the piece of equipment 56 could be a control system or any other system.

According to a first arrangement shown in FIG. 5, the umbilical connection 58 is connected directly to the first tool 38. According to another arrangement, the umbilical connection 58 is connected to the first tool 38 via the tool holder 44. According to another arrangement shown in FIG. 6, the umbilical connection 58 is connected directly to the first tool 38 and/or indirectly to the first tool 38 via the tool holder 44.

According to a particular feature of the invention, at least one piece of equipment 56 associated with the first tool 38 is connected to the first movable support 34 carrying the robotic arm 36. This solution makes it possible to reduce the length of the umbilical connection 58, which facilitates the flow of a fluid in the umbilical connection 58. Moreover, when the product applied by the first tool 38 is changed, the operation of cleaning the umbilical connection 58 causes fewer losses of product (paints, varnish, etc.), lasts a shorter time and requires fewer cleaning products, such as solvents, for example, owing to the reduced length of the umbilical connection.

As appropriate, the piece of equipment 56 is connected to:
a second movable support 50 configured to move along the guide system 32 and connected to the first movable support 34,
a support 50′ connected rigidly and permanently to the first movable support 34 or forming only the same single element with the first movable support 34.

According to one embodiment, the first tool 38 is removable, and the painting device 30 is configured to use at least a second tool in addition to the first tool 38. According to this embodiment, which is shown especially in FIG. 6, the first tool 38 is associated with:
at least a first piece of equipment 56 dedicated to the first tool 38 and connected directly or indirectly to the first tool 38 by a first umbilical connection 58,
at least a second piece of equipment 56′ common to a plurality of tools and connected directly or indirectly to the first tool 38 by a second umbilical connection 58′.

In this case, the first piece of equipment 56 is connected to the first movable support 34 by a releasable connection. When this first piece of equipment 56 is fixed to a second movable support 50, the latter is connected to the first support by a releasable connection 52. According to this embodiment, the first tool 38, each first piece of equipment 56 and each first umbilical connection 58 can be detached from the robotic arm 36 and from the first movable support 34. Each second piece of equipment 56′ is connected permanently to the first movable support 34.

After the first tool 38 and each first piece of equipment 56 dedicated thereto have been removed, a second tool can be mounted at the free end 36.2 of the robotic arm 36 in place of the first tool 38. If this second tool requires, in addition to the second piece of equipment 56′, at least one specific piece of equipment, the latter can be connected to the first movable support 34 in place of the first piece of equipment 56 dedicated to the first tool 38.

According to one configuration, at least one umbilical connection 58, especially the umbilical connection connecting the removable first tool 38 and first piece of equipment 56, is attached to the robotic arm 36 by at least one releasable connection 59, as shown in FIG. 2. Each second umbilical connection 58′ connected to a second fixed piece of equipment 56′ can be attached to the robotic arm by a non-releasable connection.

The fact that it is possible to use different tools with the robotic arm 36 makes the painting device 30 more versatile.

According to one application, a complete painting process comprises a plurality of different successive steps, such as cleaning, sanding, masking, spraying or inspection operations, each requiring a tool which may be specific to the operation, this tool optionally requiring a specific umbilical connection 58 and/or a specific piece of equipment.

When the robotic arm 36 is configured to carry different tools, unlike the prior art which provides a single umbilical connection configured to provide the different powers, the different fluids and the different data for the different tools, it is possible according to the invention to change the piece of equipment and/or the umbilical connection in order to adapt it to the tool used. Consequently, the umbilical connection has a smaller cross section than that of an umbilical connection of the prior art.

By way of example, the second piece of equipment 56′ can be a suction station, the second tool can be a sanding tool, and the second umbilical connection 58′ can be a line configured to transport air and dust from the sanding tool to the suction station.

As is shown in FIG. 11, a painting installation adapted for painting an aircraft 60 comprises at least one painting device 30.

In known manner, each aircraft 60 comprises a fuselage 62 which extends between a front point and a rear point, wings 64 which extend on either side of the fuselage 62, and a tail unit 66, positioned at the rear point, having a vertical part 66.1 and horizontal parts 66.2 situated on either side of the rear point. The aircraft 60 has a longitudinal aircraft axis XX which is horizontal when the aircraft 60 is on the ground and which passes through the front and rear points.

The fuselage 62 has a length corresponding to a dimension of the fuselage 62 taken horizontally from the front point to the rear point, and a width corresponding to a dimension of the fuselage 62 taken horizontally, in a transverse plane perpendicular to the longitudinal aircraft axis XX. The fuselage 62 has a front part 62A situated in front of the wings 64 and a rear part 62B situated behind the wings 64. Each wing 64 comprises a trailing edge 64.1 and forms a given angle with the fuselage 62, the angle being measured between the trailing edge 64.1 and the fuselage 62.

The painting installation comprises a platform S on which the aircraft 60 to be painted is immobilized, and at least one rectilinear guide system 32 oriented in a longitudinal direction, the aircraft 60 being immobilized on the platform S such that the longitudinal aircraft axis XX is substantially parallel to the longitudinal direction. As shown in FIG. 11, one or more robotic arm(s) can move along the same guide system 32.

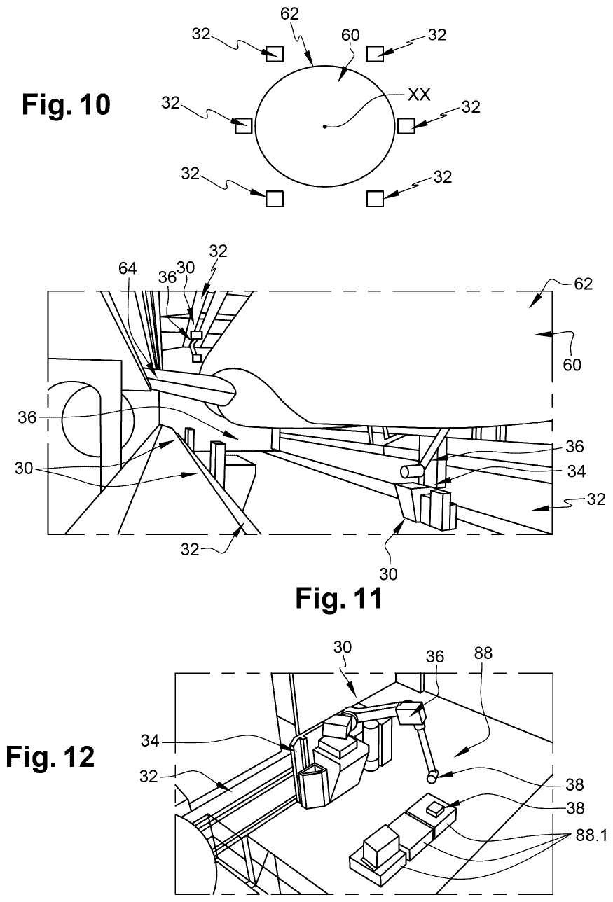

According to an arrangement shown in FIG. 10, the painting installation comprises a plurality of guide systems 32, arranged symmetrically relative to a vertical mid-plane PMV, distributed in the vertical direction and around a circle having a diameter greater than that of the fuselage of the aircraft to be painted. According to one arrangement, the painting installation comprises three guide systems 32 positioned on each side of the vertical mid-plane PMV. During operation, an aircraft 60 to be painted is immobilized on the platform S such that the longitudinal aircraft axis XX is contained within the vertical mid-plane PMV.

According to one embodiment, each guide system 32 comprises at least one slide or rectilinear rail parallel to the longitudinal direction. Each guide system 32 has a length greater than that of the aircraft 60.

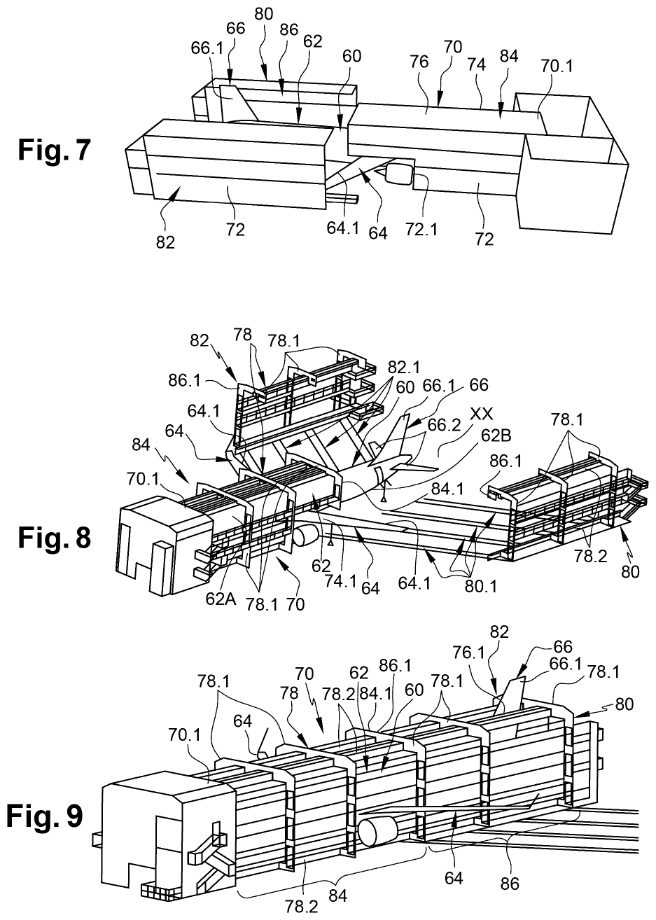

According to an embodiment shown in FIGS. 7 to 9, the painting installation comprises a painting booth 70 situated, inside a building, on a platform S (such as the ground) configured to allow an aircraft to be painted to park thereon, the painting booth 70 having first and second lateral walls 72, 74 which are parallel to one another and to the longitudinal direction, and an upper wall 76, remote from the platform S, substantially parallel to the platform S and connecting the first and second lateral walls 72, 74. According to one arrangement, the upper wall 76 is substantially horizontal and the first and second lateral walls 72, 74 are substantially vertical.

The walls 72, 74, 76 are rigid and have a length (dimension in the longitudinal direction) greater than or equal to the length of the fuselage 62 so that the fuselage 62 of the aircraft can be contained within the inner zone delimited by the painting booth 70. The first and second lateral walls 72, 74 comprise first and second lateral openings 72.1, 74.1 dimensioned to allow the wings 64 to pass through the first and second lateral walls 72, 74 while leaving a small clearance around the wings 64. By virtue of these lateral openings 72.1, 74.1, the first and second lateral walls 72, 74 are brought closer to the fuselage 62, which allows the volume of the inner zone in which the fuselage 62 is positioned to be reduced. According to one arrangement, the fuselage 62 is approximately centered between the first and second lateral walls 72, 74. According to one configuration, the first and second lateral walls 72, 74 are spaced apart by a distance of between 1.5 and 3 times the width of the fuselage.

According to one embodiment, the upper wall 76 comprises an upper opening 76.1 dimensioned to allow the tail unit 66, and more particularly its vertical part 66.1, to pass through the upper wall 76 while leaving a small clearance around the tail unit 66. By virtue of this upper opening 76.1, the upper wall 76 can be brought closer to the fuselage 62, which allows the volume of the inner zone in which the fuselage 62 is positioned to be reduced. To give an order of magnitude, the upper wall 76 is separated from the platform S by a distance of between 1.5 and 3 times the height of the fuselage 62 (dimension in a vertical direction).

As shown in FIGS. 8 and 9, the painting booth 70 comprises at least one structure 78 (shown in FIGS. 8 and 9) supporting the first and second lateral walls 72, 74, the upper wall 76 forming the enclosure of the painting booth as well as each guide system 32. According to one embodiment, the structure 78 comprises frames 78.1 positioned in transverse planes as well as longitudinal members 78.2 connecting the frames 78.1 to one another and oriented parallel to the longitudinal direction. Of course, the invention is not limited to this configuration for the structure 78.

According to one embodiment, the painting booth 70 comprises at least first and second parts 80, 82 having, respectively, at least part of the first and second lateral walls 72, 74, at least one of the first and second parts 80, 82 being movable between a spaced-apart position, corresponding to an open state of the painting booth 70 as shown in FIGS. 7 to 8, in which a fuselage of an aircraft can be positioned between the first and second parts 80, 82, and a closed-up position, corresponding to a closed state of the painting booth 70 as shown in FIG. 9.

The first part 80 comprises at least part of the first lateral wall 72 and a first portion of the upper wall 76. The second part 82 comprises at least part of the second lateral wall 74 and a second portion of the upper wall 76, the first and second portions of the lateral wall being contiguous when the first and second parts 80, 82 have been brought together and the painting booth 70 is in the closed state.

According to one configuration, the first and second parts 80, 82 are substantially symmetrical relative to the vertical mid-plane PMV. In this case, the first and second portions of the upper wall 76 comprise cut-outs so as to form the upper opening 76.1 when the first and second parts 80, 82 are brought together.

According to one configuration, the painting installation comprises, for each of the first and second parts 80, 82, at least one sliding connection 80.1, 80.2, connecting the first or second part 80, 82 and the platform S, configured to allow the first or second part 80, 82 to move in translation between the open and closed states.

In order to reduce the dimensions of the lateral openings 72.1, 74.1, each sliding connection 80.1, 82.1 forms with the vertical mid-plane PMV an angle substantially equal to that formed between the fuselage 62 and each wing 64.

According to one configuration, the painting installation comprises, for each of the first and second parts 80, 82, at least one motor system for moving the first and second parts 80, 82.

The painting booth 70 comprises a first section 84 configured to house the front part 62A and a second section 86 configured to house the rear part 62B. The first and second sections 84, 86 comprise first and second terminal faces 84.1, 86.1, respectively, positioned in transverse planes. At least one of the first and second sections 84, 86 is movable between a first position, corresponding to the closed state of the painting booth 70, in which the first and second transverse faces 84.1, 86.1 are pressed against one another, and a second position, corresponding to the open state of the painting booth 70, in which the first and second transverse faces 84.1, 86.1 are spaced apart.

According to one configuration, the first section 84 is fixed. In addition, the second section 86 comprises first and second parts 80, 82 movable between a position spaced apart from the vertical mid-plane corresponding to the open state of the painting booth 70 (shown in FIGS. 7 and 8) and a position brought closer to the vertical mid-plane corresponding to the closed state of the painting booth 70 (shown in FIG. 9). This configuration makes it possible to limit the dimensions of the movable parts and their travel.

According to one arrangement, the first section 84 comprises the lateral openings 72.1, 74.1 which open in the region of the first terminal face 84.1. In a variant, the lateral openings 72.1, 74.1 are situated on the second section 86 or straddle the first and second sections 84, 86.

According to an embodiment shown in FIGS. 7 to 9 and 12, the painting installation comprises at least one storage zone 88 configured to store at least one tool, at least one tool accessory or at least one consumable, such as a sanding disk, for example, situated as a continuation of the painting booth 70, in the region of the first end 70.1 of the painting booth 70. According to one arrangement, each guide system 32 is sufficiently long to be positioned in part in the storage zone 88.

According to one configuration, the storage zone 88 comprises at least one support 88.1 configured to carry at least one tool 38, at least one tool accessory or at least one consumable. Each support 88.1 and each guide system 32 are arranged such that a robotic arm 36 sliding along the guide system 32 is able to reach a tool 38, a tool accessory or a consumable positioned on the support 88.1.

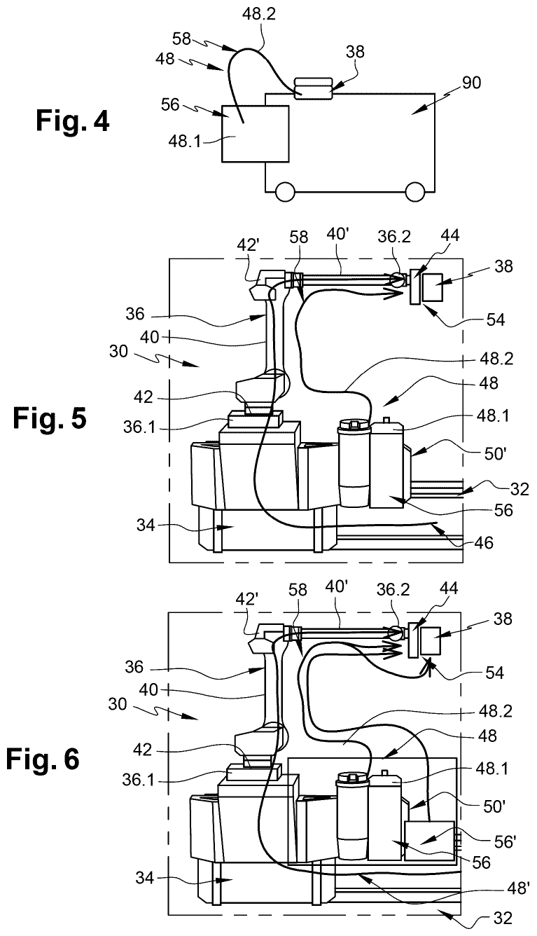

According to an embodiment shown in FIG. 4, the painting installation comprises at least one support carriage 90 configured to carry at least one tool 38, at least one tool accessory or at least one consumable. This support carriage 90 is likewise configured to carry a piece of equipment 56 connected by an umbilical connection 58 to the tool 38. This support carriage 90 allows at least one tool 38, at least one tool accessory or at least one consumable and each piece of equipment 56 connected to the tool 38 by an umbilical connection 58 to be moved and/or allows maintenance operations to be carried out on the tool 38. According to one configuration, the support carriage 90 is adapted to carry a plurality of tools simultaneously.

Of course, the invention is not limited to the painting operation. Thus, the painting device and the painting installation can be used to perform operations in preparation for the painting operation, such as an initial inspection, sanding, cleaning or masking operation, for example, and/or subsequent operations such as decoration or final inspection operations, for example.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A painting device comprising:
at least one guide system,
at least a first movable support configured to move along the guide system,
a robotic arm secured to the first movable support and having a free end,
at least a first tool connected to the free end of the robotic arm, and
at least a first piece of equipment connected by at least one umbilical connection to the first tool;
wherein the first piece of equipment associated with the first tool is connected to the first movable support carrying the robotic arm.

2. The painting device as claimed in claim 1, wherein the first piece of equipment is connected to a second movable support, the second movable support being connected to the first movable support, configured to move along the guide system.

3. The painting device as claimed in claim 2, wherein the first and second movable supports are connected by an articulated connection.

4. The painting device as claimed in claim 1, wherein the first tool is connected to the free end of the robotic arm by a first releasable connection.

5. The painting device as claimed in claim 4, wherein the first piece of equipment is connected to the first movable support by a releasable connection.

6. The painting device as claimed in claim 5, wherein the first piece of equipment is integral with a second movable support connected by a releasable connection to the first movable support.

7. The painting device as claimed in claim 6, wherein the first tool is associated with at least a first piece of equipment dedicated to the first tool and connected directly or indirectly to the first tool by a first umbilical connection, and with at least a second piece of equipment common to a plurality of tools and connected directly or indirectly to the first tool by a second umbilical connection, each first piece of equipment being releasably connected to the first movable support, each second piece of equipment being permanently connected to the first movable support.

8. The device as claimed in claim 1, wherein at least one umbilical connection is attached to the robotic arm by at least one releasable connection.

9. A painting installation configured for painting an aircraft, comprising at least one painting device as claimed in claim 1.

10. The painting installation as claimed in claim 9, wherein the painting installation comprises a plurality of guide systems arranged symmetrically relative to a vertical mid-plane and distributed around a circle having a diameter greater than that of a fuselage of an aircraft to be painted.

11. The painting installation as claimed in claim 9, wherein the painting installation comprises a painting booth which has walls forming an enclosure, and at least one structure supporting the walls and each guide system.

12. The painting installation as claimed in claim 11, wherein the painting installation comprises:
at least one storage zone configured to store at least one tool,
at least one tool accessory or at least one consumable and positioned as a continuation of the painting booth, and
at least one guide system being sufficiently long to be positioned in part in the storage zone for the at least one tool.

13. The painting installation as claimed in claim 12, wherein the storage zone comprises:
at least one support configured to carry the at least one tool,
at least one tool accessory or at least one consumable,
the at least one support and the guide system being configured and arranged such that a robotic arm sliding along the guide system is able to reach a tool, a tool accessory or a consumable positioned on the support.

14. The painting installation as claimed in claim 9, wherein the painting installation comprises at least one support carriage configured to carry at least one tool.
